(19) United States
(12) Patent Application Publication
(10) Pub. No.: US 2013/0213499 A1
(43) Pub. Date: Aug. 22, 2013

(54) NON-RETURN VALVE FOR A FLUID PUMP

(71) Applicants: Oliver Gaertner, Abstatt (DE); Daniel Gosse, Berlin (DE)

(72) Inventors: Oliver Gaertner, Abstatt (DE); Daniel Gosse, Berlin (DE)

(73) Assignee: Robert Bosch GmbH, Stuttgart (DE)

(21) Appl. No.: 13/701,546

(22) PCT Filed: Apr. 28, 2011
(86) PCT No.: PCT/EP11/56738

§ 371 Date: Apr. 26, 2013

(30) Foreign Application Priority Data
Jun. 24, 2010 (DE) 102010030464.6

(51) Int. Cl. F16K 15/02

(52) U.S. Cl. CPC F16K 15/026
USPC 137/537

(57) ABSTRACT

A non-return valve for a fluid pump, in particular of a safety brake system of a motor vehicle, includes a through-flow opening configured to be closed by a valve element. The valve element is configured to be displaced against the spring force of a valve spring made of coiled round wire to expose the through-flow opening. The round wire is coiled in one plane and is arranged with respect to the valve element such that the plane extends at least substantially perpendicularly to the displacement direction of the valve element.

The invention relates to a non-return valve for a fluid pump, in particular of a safety braking system of a motor vehicle, having a through-flow orifice which can be closed by a valve element, wherein the valve element can be displaced against the spring force of a valve spring made of a coiled round wire in order to expose the through-flow orifice.

### STATE OF THE ART

Non-return valves for fluid pumps of the type described here are known in the state of the art. Non-return valves on which high demands are placed with regard to functionality and service life are used, in particular, in safety braking systems of motor vehicles, such as ABS (automatic braking system) or ESP (electronic stability program) systems, for example. Thus, for example, non-return valves like those described in utility model specification DE 90 16 775 U1 are used. These comprise a displaceable valve element in the form of a valve ball, which is pressed against a sealing seat comprising an outlet orifice of a pressure duct by a valve spring, which is embodied as a leaf spring. If the pressure in the pressure duct increases to such an extent that the force acting on the ball from the sealing port side is greater than the prestressing force provided by the leaf spring, the ball is raised from the sealing seat and a through-flow cross section is exposed. As soon as the pressure in the pressure duct falls below a defined value, the through-flow orifice is automatically closed again by the valve element on which the valve spring impinges. The provision of the leaf spring, however, entails a high design outlay in order to ensure a reliable closing and exposure of the through-flow orifice.

Alternatively, non-return valves are also known, in which the valve spring is formed by a helically coiled round wire, therefore constituting a helical spring. Although this reduces the design outlay compared to the leaf spring, a relatively large overall axial space is needed in order to accommodate the helical spring.

### DISCLOSURE OF THE INVENTION

The non-return valve according to the invention, on the other hand, has the advantage that both the design outlay and the overall space required are minimized, whilst nevertheless ensuring a reliable closing and exposure of the through-flow orifice by the valve element. A distinguishing feature of the non-return valve according to the invention is that the round wire is coiled in one plane and is arranged in such a way relative to the valve element that the plane extends at least substantially perpendicularly to the direction of displacement of the valve element. The round wire of the valve spring is therefore not coiled helically as in a helical spring, but lies entirely in one plane, so that the overall (axial) space for the round wire and for the valve spring is small. In particular, the overall axial space here is substantially equal to the overall axially required space taken up by the known leaf spring. Providing the coiled round wire in the plane serves in particular to simplify the configuration of the flow duct downstream of the valve element, that is to say on the valve spring-side of the non-return valve, since the fluid delivered can easily flow around the round wire itself and the fluid can thereby flow easily though the valve spring. The arrangement of the valve spring and the plane at least substantially perpendicular to the direction of displacement, that is to say the direction in which the valve element can be displaced in opposition to the spring element in order to expose the through-flow orifice, affords a non-return valve which takes up little overall space, which is easy and cost-effective to produce, and which ensures a reliable exposure and closing of the through-flow orifice.

The round wire is preferably coiled in the plane at least substantially in a reniform, double-reniform, undulating or spiral shape. The reniform and the double-reniform coil of the round wire each preferably comprise at least one circular area or holding portion, which serves to hold the valve spring in a housing of the non-return valve. Inner areas or portions of the round wire serve, in particular, for bearing against the valve element. A particular feature of the spiral coil of the round wire is that the coil radius constantly increases, at least the outer coil of the round wire preferably forming a holding portion and being held in the housing of the non-return valve. A particular feature of the undulating form is that, in contrast to the coil forms previously described, the free ends of the round wire are not arranged opposite or substantially opposite. Instead, the ends of the round wire point away from one another, the round wire inbetween being coiled in the plane in an undulating shape, thereby likewise affording an elastic deformability of the valve spring perpendicular to the coil plane.

The round wire is preferably coiled in the plane in such a way that it comprises at least one valve element seating portion. The valve element seating portion serves for localized seating of the valve element, which is preferably of spherical, semi-spherical, cupped or conical design. A particular feature of the valve element seating portion is that it is shaped in such a way that, at least in the plane, the valve element is (radially) oriented by the valve element seating portion. For this purpose the valve element more preferably comprises an area of a design corresponding to the valve element seating portion, so as to ensure seating of the valve element in the valve seating portion and particularly to facilitate assembly.

The valve element seating portion and/or the valve element are more preferably designed in such a way that the valve element is locally held and in particular positively interlocks in the valve element seating portion of the round wire. This ensures that the valve element is positioned against the valve spring. Through a corresponding fixing of the valve spring in the housing of the non-return valve it is thereby also possible to ensure the positioning of the valve element as a whole in the non-return valve.

The valve element seating portion is preferably arranged at least substantially centrally, that is to say centrally in relation to the valve spring, so that the greatest possible spring force can be utilized. If two valve element seating portions are provided, for example where the valve spring is of a double-reniform design, these are preferably arranged as close together as possible and as close as possible to the middle of the valve spring in the plane. Providing two valve element seating portions serves, through the additional point of contact, to prevent any tilting of the valve element as it is displaced. Further valve element seating portions may obviously also be provided.

The round wire is more preferably held between two housing parts of the non-return valve, at least the valve element seating portion being free to oscillate as it is displaced, or being elastically deformable. By connecting the two housing parts, the valve element is therefore simply and securely oriented and/or held in the non-return valve.

Preferably at least one of the housing parts locally seats and in particular positively interlocks with the round wire. For this purpose the corresponding housing part may comprise a groove-shaped seat, for example, into which the round wire can be inserted, for example with its annular area or holding portion. This makes it possible to produce a prefabricated sub-assembly comprising the one housing part and that of the valve spring and possibly also the valve element.

According to an advantageous development of the invention at least one of the housing parts comprises a stop, limiting the maximum deformation of the valve spring. The stop is arranged and/or oriented in such a way that it prevents over-extension of the spring element and therefore plastic deformations of the spring element, thereby ensuring a long service life of the spring element.

The valve spring is preferably held prestressed in the non-return valve or in the housing of the non-return valve, so that a prestressing force impels the valve element into its closed position for closing of the through-flow orifice, in order to ensure a tight closure of the through-flow orifice.

The valve element preferably comprises a valve spring seat or is fixed to this through local inset molding of the valve spring. The valve spring seat of the valve element makes it possible to introduce an area, in particular an area of the valve element seating portion, into the valve element, so that the valve element and the valve spring are held against one another, in particular both axially and radially, through positive interlock. Alternatively, the valve spring, during manufacture of the non-return valve, is at least locally inset molded by the material of the valve element, in particular on the valve element seating portion, so that the valve element is held securely and permanently against the valve spring.

The invention will be explained below in more detail with reference to the drawing, in which:

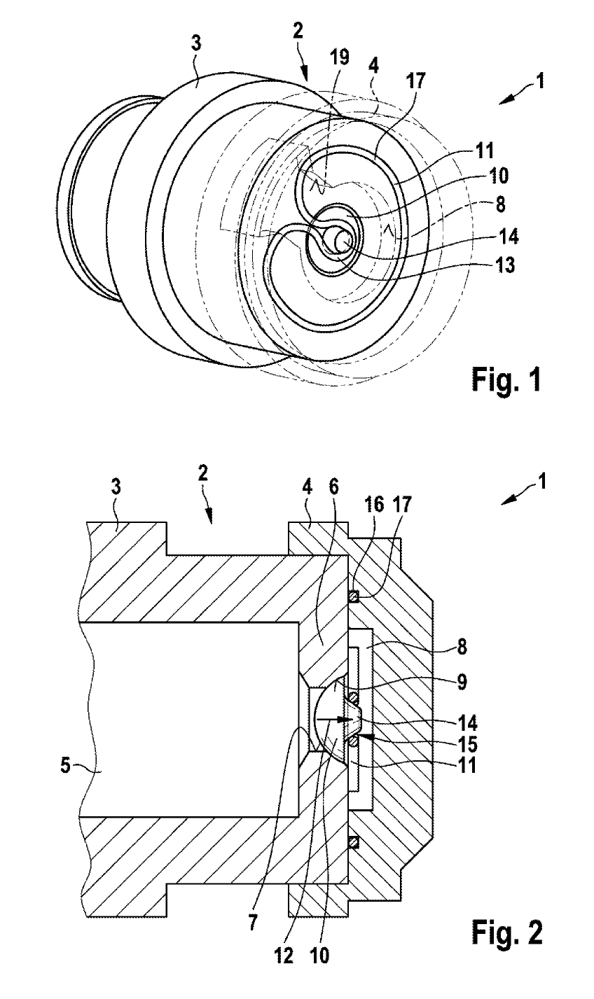

FIG. 1 shows a perspective representation of a non-return valve,

FIG. 2 shows a representation of the non-return valve in longitudinal section,

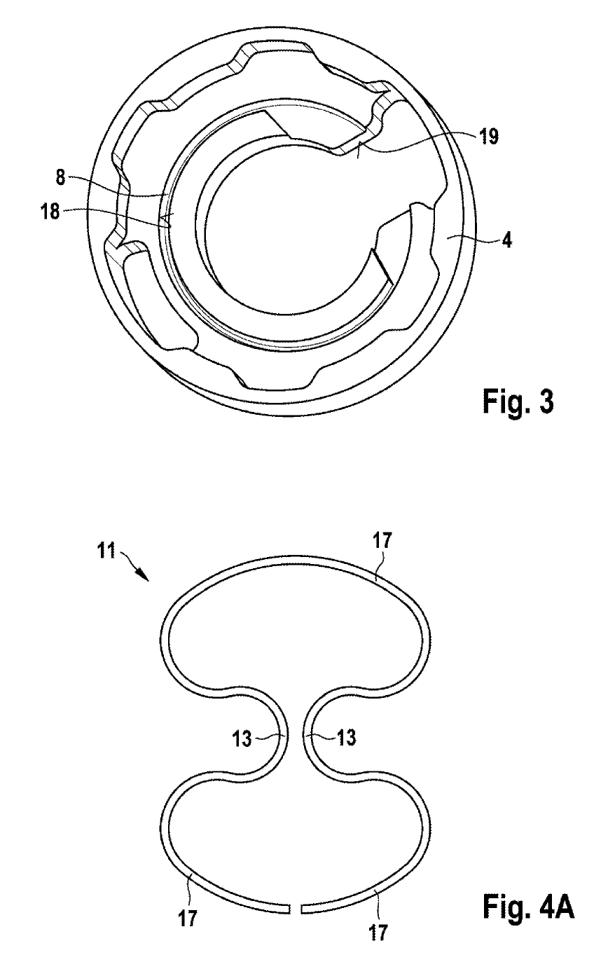

FIG. 3 shows a perspective representation of a non-return valve cover,

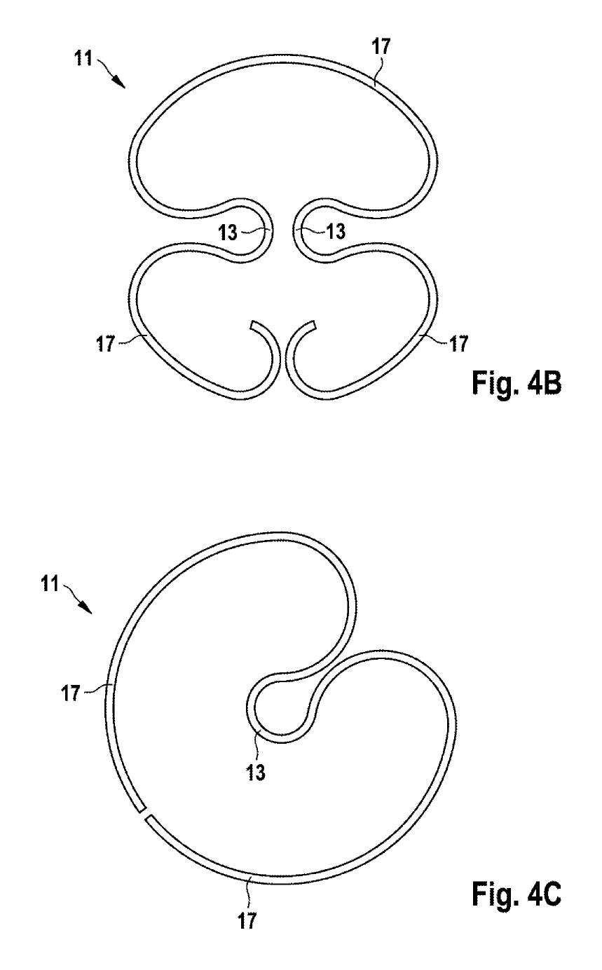

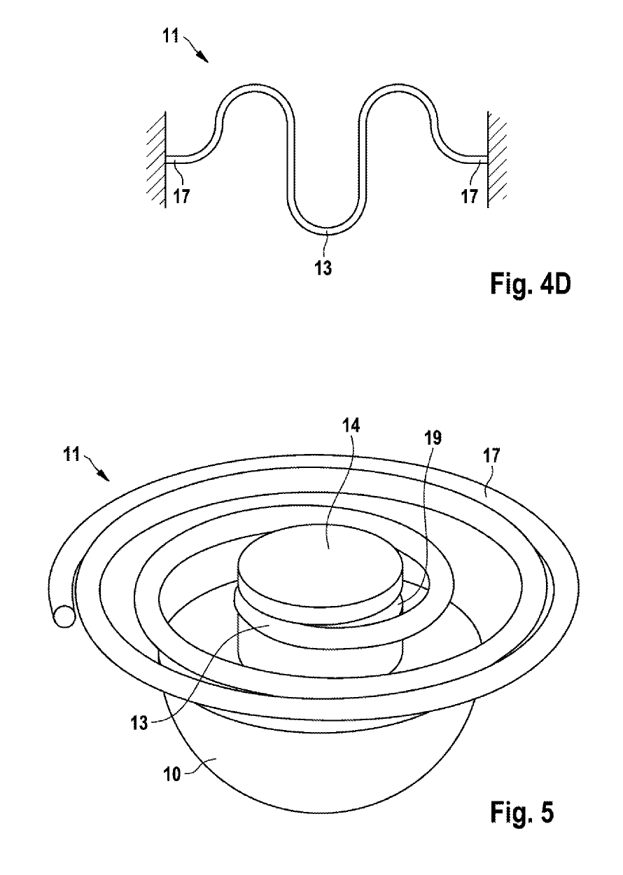

FIGS. 4A to 4D show different embodiments of the valve spring of the non-return valve and

FIG. 5 shows an exemplary embodiment of the valve spring with a valve element arranged thereon.

FIG. 1 shows a perspective representation of a non-return valve 1 of a fluid pump, not represented further here, as is used particularly in motor vehicles. The non-return valve 1 comprises a housing 2, which is of two-part design, a first housing part 3 forming a connection fitting of the fluid pump and the second housing part 4 forming a cover that can be attached to the connection fitting.

FIG. 2 shows a representation of the non-return valve in longitudinal section. It can be seen from this that the first housing part 3 is of internally hollow design, in order to form a fluid duct 5, in particular for the fluid coming from the pump. Whilst the circumferential surface of the housing part 3 is of closed design, the end face 6 of the first housing part has a through-flow orifice 7. The through-flow orifice 7 connects the fluid duct 5 to a fluid duct 8, formed between the cover 4 and the end face 6 of the first housing part 3.

On the side facing the second housing part 4, the through-flow orifice 7 comprises a sealing seat 9, against which a valve element 10 is pressed by means of a prestressing force for closing the through-flow orifice 7. Here the valve element 10 is of substantially semi-spherical design, the side of the valve element 10 having the spherical shape being turned towards the through-flow orifice 7, so that the spherical outer surface of the valve element 10 interacts with the correspondingly shaped sealing seat 9 of the through-flow orifice 7 to form a seal.

The prestressing force pressing the valve element 10 against the sealing seat 9 is applied by a valve spring 11. As can best be seen from FIG. 1, the valve spring 11 is formed from a round wire, which is coiled in one plane in such a way that it assumes a reniform shape in the plane, its two free ends being arranged so that they align with one another or are situated opposite one another. The valve spring 11, and the plane in which the round wire is coiled, lies perpendicularly to the direction in which the valve element 10 can be displaced against the prestressing force, as indicated by an arrow 12 in FIG. 2. Here the valve spring 11 comprises a valve element seating portion 13, which is formed by the reniform design or coiling of the round wire. The valve element 10 and the valve spring 11 here are designed in such a way that the valve element seating portion 13 seats the valve element at least locally.

For this purpose, on its rear side remote from the through-flow orifice 7, the valve element 10 here comprises a truncated cone-shaped projection 14, the diameter of which diminishes from the valve element towards the valve spring 11. The height of the projection 14 here is preferably at least equal to the cross-sectional diameter of the round wire 11. The valve element seating portion 13 is of substantially annular design and is arranged centrally in relation to the valve spring 11. The valve element seating portion 13 and the projection 14 of the valve element 10 here are designed in such a way that the circumference of the projection 14 at its foot area is at least substantially equal to the inside diameter of the valve element seating portion 13, so that when the projection 14 is fully inserted into the seat 15 formed by the valve element seating portion 13 it is held, at least radially, in a positive interlock by the valve element seating portion 13. Due to the conical design of the projection 14, the projection 14 has a centering action when introduced into the valve element seating portion 13 or into the seat 15, thereby facilitating assembly. The valve element 10 can be introduced into the seat 15 until either the circumference of the projection 14 corresponds to the inside diameter of the seat 15 or until the valve element 10 butts against the valve spring 11 with its substantially flat rear side.

As can also best be seen from FIG. 2, on its underside facing the end face 6 the second housing part 4 comprises a substantially annular seat 16, which is of groove-like design. The spring element 11 with its external holding portion 17, which substantially corresponds to a half-ring, is preferably held by positive interlock and/or non-positively in the seat 16. In the area in which the holding portion 17 merges into the valve element seating portion 13, the valve spring 11 or the round wire rests on the outside of the end face 6 and/or on the rear side of the valve element 10. The fluid duct 8 here is formed so high or so low that the valve element seating portion 13 is free to oscillate in the direction of the arrow 12 in an elastically deformable manner.

In operation the valve spring 11 forces the valve element 10 into the sealing seat 9, as described above. Should the force acting on the valve element 10 in the direction of the arrow 12 due to the pressure in the fluid duct 5 exceed the prestressing force, however, the valve element 10 is displaced in the direction of the arrow, so that the valve spring 11 and in particular its valve element seating portion 13 is elastically deformed. Due to the positively interlocking seat of the valve element 10 in the valve element seating portion 13, the valve element 10, as it is being displaced, is guided by the valve spring. In order to prevent over-extension of the valve spring 11, the second housing part 14 preferably comprises a stop (not shown here), up to which the valve element seating portion 13 and the valve element 10 can be displaced. This durably ensures the functionality of the valve spring and the non-return valve 1. The stop is preferably formed by the inside of the fluid duct 8 or the second housing part 4. If the pressure in the fluid duct diminishes again, the valve element 10 is forced back in the direction of the sealing seat 9, in order to seal this.

The advantageous design of the valve spring 11 that results from the round wire coiled in the plane means that little overall space is taken up in an axial direction, that is to say in the direction of the arrow 12, but the valve function is nevertheless durably ensured.

FIG. 3 shows a perspective view of the second housing part 4 of the non-return valve 1 from below. The fluid duct 8 is formed by a depression 18, which is of substantially cylindrical shape. Furthermore the second housing part 4 comprises a recess 19, which from the depression 18 leads radially outwards to the connection, not further represented here. The fluid flowing through the through-flow orifice 7 of the first housing part 3 is thus able to flow off through the recess 18 and the cut-out 19.

FIGS. 4A to 4D show different embodiments of the valve spring 11. FIG. 4C here shows the valve spring in the form in which it is also provided in the exemplary embodiment according to FIGS. 1 and 2. FIG. 4A shows the valve spring 11 in a double-reniform configuration, in which two inner valve element seating portions 13 are provided. The valve element preferably comprises corresponding projections, which each interact with one of the valve element seating portions 13. This ensures a displacement of the valve element in such a way that tilting of the valve element during displacement is prevented.

FIG. 4B shows a similar double-reniform embodiment of the valve spring 11, which differs from the embodiment according to FIG. 4A in that the free ends of the round wire do not point directly towards one another or align with one another but, bent inwards, lie pointing away from one another in the plane of the valve spring 11. The cover or the second housing part 4 is preferably designed to correspond to the valve spring according to the exemplary embodiments in FIGS. 4A and 4B, in such a way that in each case both valve element seating portions 13 are elastically deformable, in order to allow a displacement of the valve element 10. Obviously each valve element seating portion 13 may in each case have assigned to it an individual valve element, which in each case closes or exposes a through-flow orifice of the first housing part 3.

FIG. 4D shows an exemplary embodiment of the valve element 11 in a schematic representation, in which the round wire is coiled in one plane in such a way that its two ends are arranged pointing away from one another, and between the two ends the round wire runs in an undulating shape. Here the valve element 11 at the same time likewise comprises a valve element seating portion 13, which is formed by one of the undulations.

FIG. 5 shows an exemplary embodiment of the valve spring 11 with the valve element 10 arranged thereon. In this exemplary embodiment the valve spring 11 is coiled spirally in the plane, at least the outer coil forming a holding portion 17 and the inner coil forming the valve element seating portion 13. In this exemplary embodiment the valve element 10, on the outer circumferential surface of the projection 14, comprises a groove-like depression 19, into which the inner coil of the valve spring 11 is inserted, at least locally, preferably in a positively interlocking or non-positive manner. The valve element 10 is thereby fixed to the valve spring 11, so that both elements together form a prefabricated sub-assembly, thereby facilitating assembly and further increasing the durability of the non-return valve 1.

In an alternative development the valve element 10 is at least locally inset molded around the valve element seating portion 13, thereby ensuring an especially firm connection between the valve spring 11 and the valve element 10. The housing part 4 may be caulked, pressed or screwed to the housing part 3 or connected in some other way known to the person skilled in the art. Here the valve spring 11 is held wedged, at least by its holding portion 17, between the second housing part 4 and the first housing part 3, particularly so that a prestressing force is applied to the valve element 10, at least when the rear side of the valve element 10 resting on the sealing seat 9 protrudes beyond the end face 6.

1. A non-return valve for a fluid pump, comprising:
a valve element;
a housing defining a through-flow orifice, the through-flow orifice being configured to be closed by the valve element; and
a valve spring made of coiled round wire, the valve element being configured to be displaced against a spring force of the valve spring to expose the through-flow orifice,
wherein the round wire is coiled in one plane and is arranged in such a way relative to the valve element that the plane extends at least substantially perpendicularly to the direction of displacement of the valve element.

2. The non-return valve as claimed in claim 1, wherein the round wire is coiled in the plane at least substantially in a reniform, double-reniform, undulating, or spiral shape.

3. The non-return valve as claimed in claim 1, wherein the round wire is coiled in the plane in such a way that it comprises at least one valve element seating portion.

4. The non-return valve as claimed in claim 3, wherein one or more of the valve element seating portion and the valve element are designed in such a way that the valve element seating portion locally seats the valve element.

5. The non-return valve as claimed in claim 3, wherein the valve element seating portion is arranged at least substantially centrally.

6. The non-return valve as claimed in claim 1, wherein the round wire is held between two housing parts of the non-return valve, at least the valve element seating portion being free to oscillate as it is displaced.

7. The non-return valve as claimed in claim 6, wherein at least one of the housing parts locally seats the round wire.

8. The non-return valve as claimed in claim 6, wherein at least one of the housing parts comprises a stop that limits the maximum deformation of the valve spring.

9. The non-return valve as claimed in claim 1, wherein the valve spring is held prestressed.

10. The non-return valve as claimed in claim 1, wherein the valve element comprises a valve spring seat or is fixed to this through local inset molding of the valve spring.

11. The non-return valve as claimed in claim 1, wherein the fluid pump is the pump of a safety braking system of a motor vehicle.

12. The non-return valve as claimed in claim 4, wherein the valve element seating portion positively interlocks with the valve element.

13. The non-return valve as claimed in claim 7, wherein the at least one of the housing parts positively interlocks with the round wire.
